(19) United States
(12) Patent Application Publication
(10) Pub. No.: US 2024/0346117 A1
(43) Pub. Date: Oct. 17, 2024

(54) SYSTEMS AND METHODS FOR INTERACTIVE DISTRIBUTED COMPUTING

(71) Applicant: Rhino Healthtech, Inc., Boston, MA (US)

(72) Inventors: Yuval Baror, Ramat Hasharon (IL); Yaron Blinder, Haifa (IL); Michael Loewenstein, Berlin (DE); Tal Einat, Nes Ziona (IL); Ittai Dayan, Swampscott, MA (US)

(73) Assignee: Rhino Healthtech, Inc., Boston, MA (US)

(21) Appl. No.: 18/633,013

(22) Filed: Apr. 11, 2024

Related U.S. Application Data
(60) Provisional application No. 63/495,626, filed on Apr. 12, 2023.

(51) Int. Cl. G06F 21/31

(52) U.S. Cl. CPC G06F 21/31

(57) ABSTRACT

Systems and methods for providing interactive distributed computation are provided. The system can include a server accessible by a client agent, the client agent residing on a network associated with a site.

### CROSS-REFERENCE TO RELATED APPLICATIONS

This application claims priority to U.S. Provisional Application No. 63/495,626, filed Apr. 12, 2023, which is herein incorporated by reference in its entirety.

### BACKGROUND OF THE DISCLOSURE

With the increasing popularity of Artificial Intelligence (AI), there is an increasing need for access to large amounts of diverse data to train and validate AI models. In some industries, such as healthcare, accessing large amounts of diverse data is limited due to reasons related to privacy, regulation, cost, etc.

### SUMMARY OF THE DISCLOSURE

According to one aspect of the present disclosure, a system for providing interactive distributed computation can include a server accessible by a client agent, the client agent residing on a network associated with a site. The server can include instructions which, when executed by one or more processors, cause the server to perform a process operable to: create a project based on an indication received from a user device external from the network of the client agent; receive a software container image from the user device, the container image comprising code to be executed and a user interface component; identify a dataset accessible by the client agent; associate at least a subset of the dataset with the project; trigger execution of the container image by the client agent, wherein the client agent executes a software container based on the software container image in an isolated manner; transmit a link to access a user interface (UI) of the container image to the user device; in response to receiving an indication that the user device has accessed the link, authenticating the user device and validating an authorization of the user device to access the UI of the container image; establish a connection between the user device and the isolated container, the connection comprising an encrypted communication channel; pass signals from the user device to the isolated container; and pass signals from the isolated container to the user device.

In some embodiments, passing the signals from the user device to the isolated container can include passing at least one of mouse movements, clicks, and keyboard key presses to the user device. In some embodiments, the system can include a network policy on the isolated container that blocks outgoing access. In some embodiments, the server communicates with the client agent via an asynchronous message queue mechanism or via a synchronous communication mechanism. In some embodiments, the user interface component comprises a containerized application. In some embodiments, the server can be configured to terminate a session automatically after a predefined idle period or based on an indication from the user device. In some embodiments, authenticating and authorizing the user device can include authenticating using at least one of a username and password, single-sign on (SSO), JSON web token (JWT), or valid authentication token, and authorizing can include at least one of role-based access control (RBAC) permission checks, user-based access, access to any authenticated user, or public access.

In some embodiments, the encrypted communication channel can be configured to encrypt all data sent over the connection. In some embodiments, the encrypted communication channel can include a Transport Layer Security (TLS) tunnel. In some embodiments, the server can be configured to store an identifier of an interactive session in a cloud database and an indicator that the interactive session is active. In some embodiments, the server can be configured to query the cloud database at a predetermined frequency to determine whether the interactive session is active.

According to another aspect of the present disclosure, a distributed computing system can include a client agent that resides on a network and is communicably coupled to a server that resides outside of the network. The client agent can include instructions which, when executed by one or more processors, cause the client agent to perform a process operable to: receive a software container image from the server via an encrypted communication channel, the container image comprising code to be executed and a user interface component; execute the container image in an isolated manner; receive a connection to a user device via the encrypted communication channel; receive, by the isolated container, signals from the user device; and manipulate a user interface displayed on the user device based on the signals received from the user device.

In some embodiments, passing the signals can include at least one of mouse movements, clicks, and keyboard key presses at the user device. In some embodiments, the system can include a network policy on the isolated container that blocks outgoing access. In some embodiments, the server communicates with the client agent via an asynchronous message queue mechanism or via a synchronous communication mechanism. In some embodiments, the user interface component can include a containerized application. In some embodiments, the encrypted communication channel can be configured to encrypt all data sent over the connection. In some embodiments, the encrypted communication channel can include a Transport Layer Security (TLS) tunnel.

In some embodiments, the client agent can include at least one of a cloud-based server in a virtual private cloud, an on-site provisioned virtual machine, or an on-site server with access to data in a network and compute processing devices including one or more of CPUs or GPUs. In some embodiments, the containerized application can include at least one of a viewing or annotation tool.

### BRIEF DESCRIPTION OF THE FIGURES

FIG. 1 is a block diagram of an example system for interactive distributed computing, according to some embodiments of the present disclosure.

FIG. 2 is an example process for interactive distributed computing, according to some embodiments of the present disclosure.

FIG. 3 is another example process for interactive distributed computing, according to some embodiments of the present disclosure.

FIG. 4 is an example user interface within the system of FIG. 1, according to some embodiments of the present disclosure.

FIG. 5 is another example user interface within the system of FIG. 1, according to some embodiments of the present disclosure.

FIG. 6 is an example server device that can be used within the system of FIG. 1 according to an embodiment of the present disclosure.

FIG. 7 is an example computing device that can be used within the system of FIG. 1 according to an embodiment of the present disclosure.

### DESCRIPTION

The following detailed description is merely exemplary in nature and is not intended to limit the invention or the applications of its use.

Distributed computing systems can allow users to package code into a software container and transmit the container to various sites or locations for execution. The code can then be executed at those sites or locations on different data, thus providing different outputs and heuristics. For example, a distributed computing system can be used for federated learning processes or other computing tasks (e.g., preprocessing).

A solution to data access in cases in which data sharing is limited, is to work with distributed datasets, such that instead of centralizing all of the data in one place, the data remains at each site (e.g., each hospital in the case of healthcare), thus allowing each institution to retain full control over their data. This solution utilizes distributed computing and federated learning in order to allow calculations to be performed and AI models to be developed in this distributed setting.

Embodiments of the present disclosure relate to systems and methods that provide interactive distributed computing. The disclosed principles utilize interactive remote containers in conjunction with a distributed computing system. The interactive remote containers enable a user to run a separate application or arbitrary code in connection with the containerized code being executed and interact via a user interface. The disclosed principles can also utilize an encrypted tunnel between the user device, on-premises computing devices, and a cloud server. For example, the disclosed system can enable a user to utilize a data visualization application (e.g., a 3D video editing software) in conjunction with the distributed computing system. The disclosed system enables the user to run the data visualization application remotely on remote data (i.e., data contained at external sites/locations) and interact with the software. The code is executed remotely but the user can connect via a user interface on their own personal device, similar to a remote desktop. In another example, a user can run a medical imaging viewing and annotation tool (e.g., 3D Slicer) on a remote client and access the remote dataset associated with said on-premises computing device. The user can annotate data with 3D Slicer and store the output dataset with its annotations.

In addition, the disclosed system utilizes various safeguards to prevent the software/arbitrary code from exfiltrating, extracting, or otherwise compromising the remote data. For example, the system limits and/or removes network access from the server performing the computations such that it cannot otherwise communicate with the external world, only with the data provided to it. The code can be executed in a highly contained and secured environment and can be “read only.” The user interface on the user device allows the user to securely and remotely connect through an encrypted channel that also authenticates the user, validates permission to execute the code on the selected dataset, and maintains a full audit log of those who have run containers and of the code that was run.

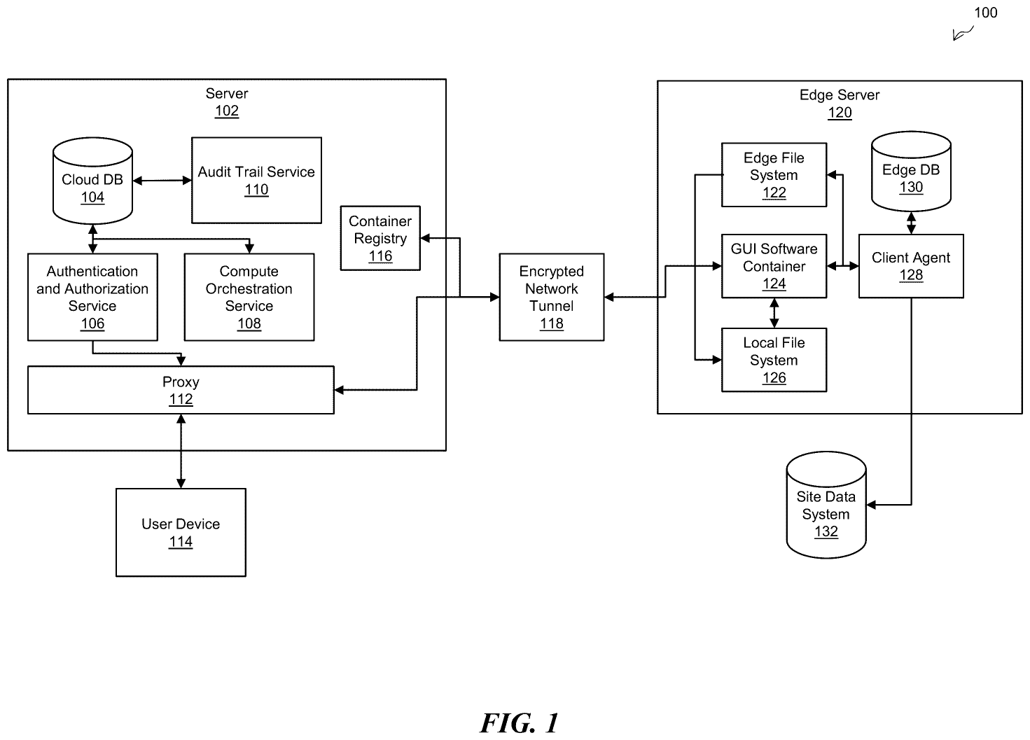

FIG. 1 is a block diagram of an example system 100 for interactive distributed computing, according to some embodiments of the present disclosure. In some embodiments, the system 100 can operate within or in conjunction with (i.e., some components may be overlapping) with the system described in U.S. application Ser. No. 18/180,710, titled “Systems and Methods for Using Federated Learning in Healthcare Model Development,” and Ser. No. 18/180,713, titled “Systems and Methods for Using Distributed Computing in Healthcare Model Development,” both of which are herein incorporated by reference in their entireties. The system 100 includes a server 102 and an edge server 120, which are communicably coupled via an encrypted network tunnel 118. Although there is only one edge server 120 shown in FIG. 1, any number of edge servers 120 is possible. In some embodiments, the edge server 120 can be installed on-premises at each of one or more sites or other similar sites. In such embodiments, the edge server 120 is communicably coupled to data systems at the sites 132, which can be a site's internal computing system and/or network. In some embodiments, the edge server 120 can operate in the cloud, such as in a virtual private cloud being used by the associated institution. By virtue of its connection to the site's data system 132, the edge server 120 can have access to the institution (e.g., research institution, hospital, etc.) personal data (with or without PII).

In some embodiments, the encrypted network tunnel 118 can include an ad-hoc Transport Layer Security (TLS) tunnel that encrypts all data sent over the connection. In some embodiments, the encrypted network tunnel 118 can be terminated upon termination of the software container code (i.e., either by a user or via keep-alive functionality). In some embodiments, client agents 128 are unable to communicate with each other via the encrypted network tunnel 118.

In some embodiments, the server 102 can be a cloud server and can include multiple services, each handling a specific subset of functionality. In some embodiments, the services can be included in a single monolith and may share a single database. In other embodiments, the services may rely on separate databases depending on their specific requirements and interdependences. For example, the audit trail service 110 could have its own database to persist data for long periods of time and not be prone to frequent updates and schema migrations. In addition, the server 102 can be hosted on AWS, although this is merely exemplary in nature.

The server 102 includes a cloud database 104, an authentication and authorization service 106, a compute orchestration service 108, an audit trail service 110, a proxy 112, and a container registry 116. In some embodiments, the cloud database 104 can be a Postgres database. The cloud database 104 is configured to store structured data that doesn't include any personal data e.g., personal identifiable information (PII) or protected health information (PHI). In some embodiments, the cloud database 104 can include an AWS Aurora instance. The authentication and authorization service 106 is configured to perform various authentication and authorization procedures in order to allow users to access external data for computations, such as the data contained at a site data system 132. For example, the authentication and authorization service 106 can perform a process that authenticates the user, such as via a login process, AWS account validation, or another Single Sign On (SSO) account validation process, and validates authorization of the user to execute the interactive distributed code on the selected dataset, e.g. based on role based access control (RBAC). The compute orchestration service 108 is configured to handle orchestration of distributed computing using container orchestration services such as kubernetes. The server 102 also includes a web-based user interface (not shown) that functions as a gateway through which users interact with the system 100. In some embodiments, the web-based user interface can include an AWS EC2 server running nginx, and user interaction can be performed in Javascript with a web framework like React, Vue, Angular, or other Javascript frameworks. The server 102 also includes a REST API (not shown) that allows users to interact programmatically with the system 100. In some embodiments, a Software Development Kit (SDK) can be provided (e.g., in Python) to make programmatic interaction with server 102 easier.

In some embodiments, the cloud database 104 can have various entities created within it as part of the interactive computation procedures described herein, such as Activity, Code/Model, FederatedAction, and Cohort(s). A FederatedAction can represent an interactive computing run. In addition, the server 102 can perform checks of the cloud database 104 to determine if a model is already running for a given site or group of users. In some embodiments, the server 102 can be configured to maintain the “liveliness” of a current interactive computing session and to provide details about the code (e.g., whether it is running). A record can be kept in the cloud database 104 to indicate that the session is active. In some embodiments, a kubernetes cron job can be used to check the status of all running model sessions and terminate the expired ones (e.g., after fifteen minutes of being idle).

The audit trail service 110 is configured to maintain an audit trail for activities associated with the executed of the distributed code and connection to an interactive session. In some embodiments, the server 102 can utilize the container registry 116 and a push command to provide a mechanism with which to upload software containers (e.g., to GUI software container 124) to the cloud environment in a way that minimizes the data that is uploaded. This can be achieved by analyzing the different layers within the software container and only uploading layers that have any difference from the version in the cloud. In some embodiments, container input data can be deleted when the container finishes running. In some embodiments, container output data can be deleted after the container finishes running and any output cohort has been imported into the system. In some embodiments, container images can be purged after a time period, such as thirty days. In some embodiments, containers may not have access to any other files on the host operating system. In some embodiments, containers may not have access to communicate with other containers (e.g., databases). In some embodiments, containers may not be allowed to communicate with any external service over the Internet. In some embodiments logs collected from the container can be cleaned before sending back to the cloud, such as having sensitive data redacted, log lines truncated, and/or limiting the number of log lines being sent back to the cloud. In some embodiments logs collected from the container can be stored locally and not sent to the cloud at all. In some embodiments, there can be limitations on resources (e.g., CPU, GPU, memory, disk space, etc.) to avoid abuse of resources.

The containers hosted in the container registry 116 and container orchestration services can be used for distributed computing. They can be used to transmit a container to a client agent (e.g., client agent 128), where it can be run on that site's data. In some embodiments, this can be used to facilitate (1) pre-processing or post-processing, such as transforming data in one format into another format, filtering rows, altering column data, performing data imputation, normalizing data, etc.; (2) reviewing, labeling, or annotating datasets (3) model validation, such as taking a model and a validation set and running a model inference for each row in the validation set, adding the predicted values to each row, and comparing those to a ground truth; and (4) federated querying, such as performing data aggregation at multiple sites to understand data distributions or other data queries. In some embodiments, the container registry 116 may contain pre-built containers for common tasks like converting between common data types (e.g., DICOM to png), common tools (e.g. Jupyter Notebook, 3D Slicer), or general-purpose tasks (e.g., receiving one or more lines of code and running them on selected cohorts at each site). In some embodiments, the server 102 can be communicably coupled to a user device 114 via a proxy 112 such that this proxy can perform authentication and authorization using the authentication and authorization service 106. In some embodiments, the proxy can be an NGNIX ingress controller that exposes an encrypted endpoint (e.g., user device 114) to the server 102 via a network load balancer (not shown in FIG. 1). In some embodiments, the network load balancer can be exposed publicly so that any user can connect to it. In some embodiments, a proxy pass record can be added to the proxy configuration for each client agent 128.

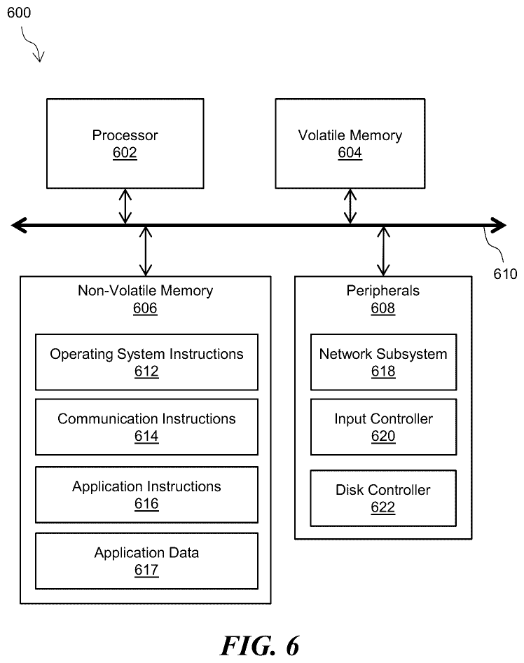

Server device 102 may include any combination of one or more of web servers, mainframe computers, general-purpose computers, personal computers, or other types of computing devices. Server device 102 may represent distributed servers that are remotely located and communicate over a communications network, or over a dedicated network such as a local area network (LAN). Server device 102 may also include one or more back-end servers for carrying out one or more aspects of the present disclosure. In some embodiments, server device 102 may be the same as or similar to server device 600 described below in the context of FIG. 6. In some embodiments, server 102 can include a primary server and multiple nested secondary servers for additional deployments of server 102. This can enable greater scalability and deployability, as well as the ability to deploy asset-based severity scoring systems at a specific premises if requested by a user. In some embodiments, server device 102 may run a container orchestration service (e.g., Kubernetes) to manage the different services being run on it.

In some embodiments, the server 102 is communicably coupled to the edge server 120 via an encrypted network tunnel (e.g., https) that allow only verified requests to move between the server 102 and the server 120. In some embodiments, the server 102 can communicate with the client agent 128 via an asynchronous message queue mechanism or via a synchronous communication mechanism.

In some embodiments, the server 120 includes an edge file system 122, a graphical user interface (GUI) software container 124, a local file system 126, a client agent 128, and an edge database 130. In addition, the client agent 128 is connected to the site's data system 132. In some embodiments, a network policy on the GUI software container 124 blocks all outgoing internet access.

The client agent 128 can also access the server 102 in a cloud environment for orchestration, which can include the cloud environment requesting that the agent 128 perform specific actions (e.g., initiate a interactive session, make specific datasets available to the container, analyze the outputs from the container, etc.). The client agent 128 would then perform the requested action and provide a response to the cloud. In some embodiments, the client agent 128 can include software installed in one or more of the following ways: (1) a cloud-based site-provisioned server in a virtual private cloud (VPC); (2) an on-site site-provisioned virtual machine (VM); or (3) an on-site server. In some embodiments, the minimum technical specifications of the client agent 128 can be pre-defined by the entity managing the cloud environment. In some embodiments, the client agent 128 can include a set of software containers with different components to be run and a management/orchestration layer (e.g., Kubernetes) for the containers.

The client agent 128 is further communicably coupled to an edge database 130 and edge filesystem that may store copies of the data for the interactive distributed code to have access to.

In some embodiments, the client agent 128 can import datasets from the site's data systems to which it was provided access.

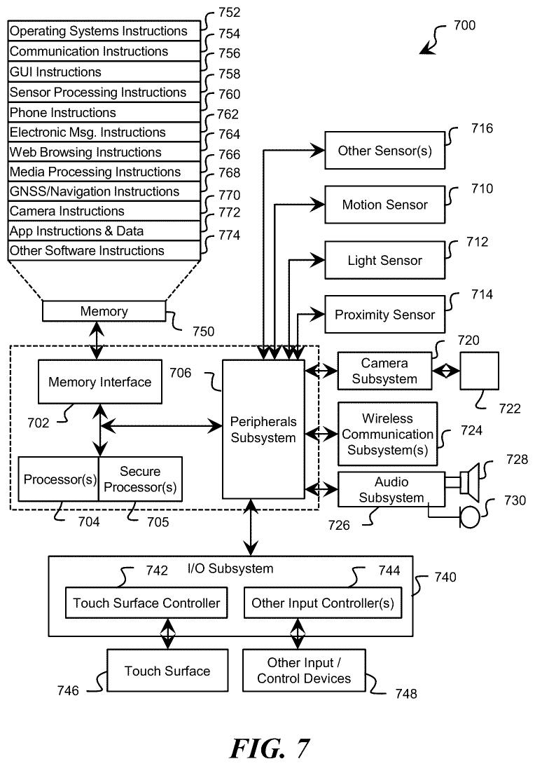

The system also includes a user device 114 that allows a user (e.g., project leader or researcher) to interface with the server 102 and edge server 120. A user device 114 can include one or more computing devices capable of receiving user input and or communicating with the server 102. In some embodiments, a user device 114 can be representative of a computer system, such as a desktop or laptop computer. Alternatively, a user device 114 can be a device having computer functionality, such as a personal digital assistant (PDA), a mobile telephone, a smartphone, or other suitable device. In some embodiments, a user device 114 can be the same as or similar to the device 700 described below with respect to FIG. 7. In some embodiments, the system 100 can include any number of user devices 114.

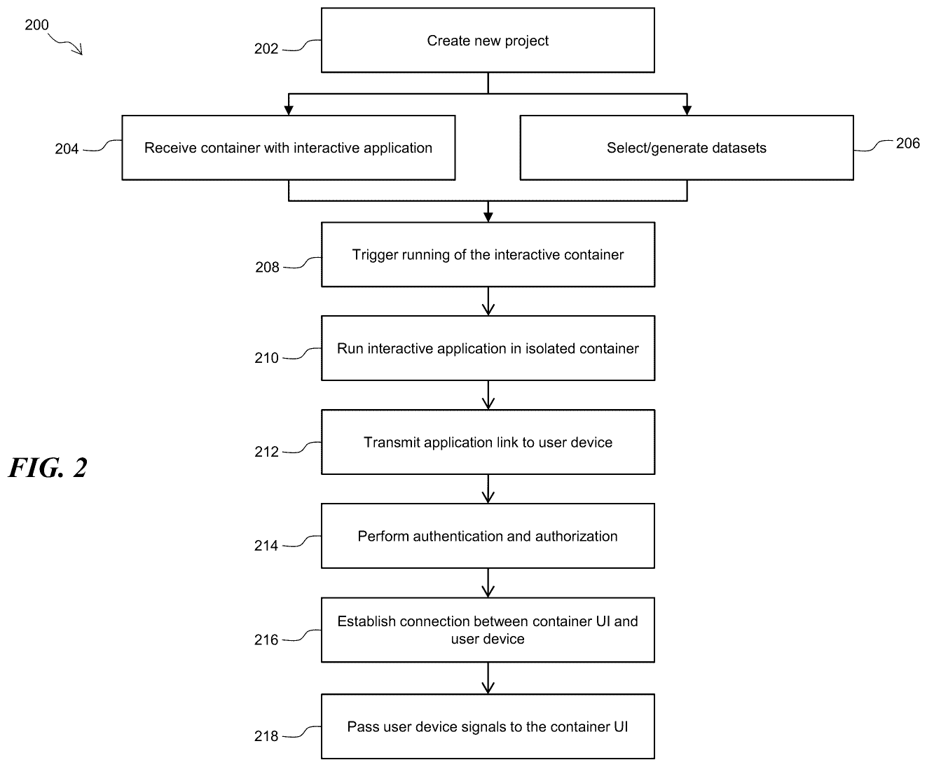

FIG. 2 is an example process 200 for interactive distributed computing, according to some embodiments of the present disclosure. In some embodiments, one or more steps of the process 200 can be performed by the server 102 and its various services. In some embodiments, prior to process 200 being performed, a client agent 128 is installed and established at a location or site. In addition, process 200 can be performed to run various pieces of code across different participating sites (e.g., different collaborating hospitals and/or institutions) in an interactive manner, such that the user can run said code and interact via another arbitrary application, such as a 3D visualization tool (e.g., 3DSlicer). For example, pre-processing, model validation, and federated querying can be computed in a flexible and distributed manner. Furthermore, process 200 allows a user to interact with distributed data using their preferred tooling. For example, a user may run Jupyter Notebook on a remote site (i.e., on premises as opposed to on the user's site) to better enable data harmonization efforts and use third party annotation tools, (e.g., 3D Slicer) to interact with the results.

At block 202, the server 102 creates a new project, for example based on an indication received from the user device 114. The indication can have been sent based on a user (e.g., an employee or researcher at the first location) interacting with a web interface that allows him/her to specify the project name, description, and permissions. In some embodiment, the server 102 can also assign the project to a workgroup associated with the user.

At block 204, the server 102 receives a container with an interactive application from the user device 114. In some embodiments, receiving the container can include receiving a software container image including code to be executed and a user interface component. The container can include the code or application to be executed, such as a data visualization application to be run on various datasets. In some embodiments, the server 102 can alternatively build a container image based on code received from the user. The container is pushed to the server 102 by the user. For example, the server 102 can utilize the container registry 116 and the user can initiate a push command to push the container from the user device to the container registry 116. In addition, the GUI software container 124 includes code for an interactive application (i.e., arbitrary code that a user wishes to utilize in conjunction with the distributed computing). For example, a user may wish to interact with a data visualization application, data annotation tool, data de-identification application, or other containerized application running on a remote client (e.g., client agent 128).

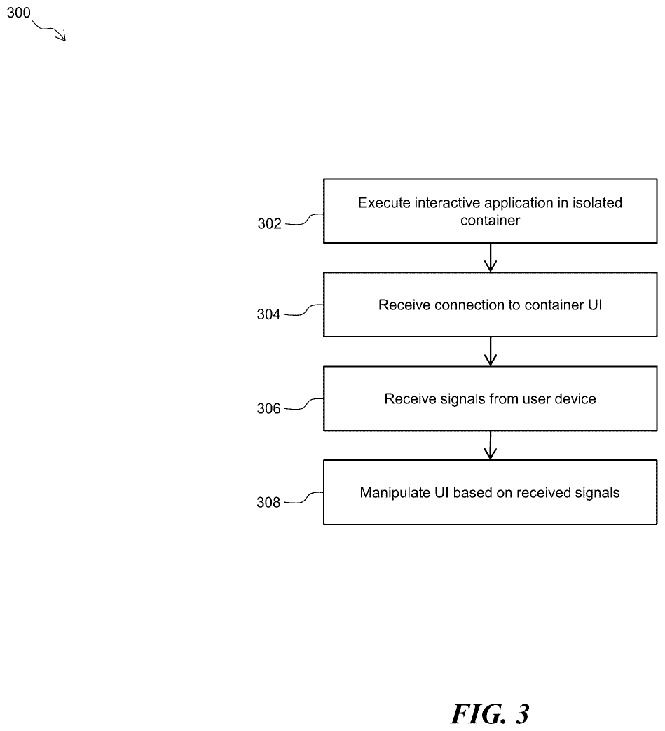

At block 206, the edge server 120 generates one or more cohorts (datasets). In some embodiments, generating a cohort can include defining a subset of data in each cohort that is permitted for use within the process 200, and this includes data maintained on edge server 120 associated with the data system 132. For example, the server 102 initially can receive a request from the user device 114 to import a cohort. This request is transmitted to client agent 128 via the encrypted network tunnel 118 to perform the data import. For example, the server 102 receives a request to import a first dataset from the user at the first/main location. The server 102 generates a cohort object placeholder for the first dataset and associates the cohort object placeholder with the project created at block 202. These can be stored in cloud database 104. The server 102 then sends an import command to client agent 128, which imports the cohort data from the first dataset locally, optionally validates that it conforms to a schema, and then creates a cohort object in edge database 130, associated to the cohort object placeholder via a shared unique identifier. Additional details with respect to generating a cohort are discussed in relation to FIG. 3 of U.S. application Ser. No. 18/180,710, titled “Systems and Methods for Using Federated Learning in Healthcare Model Development,” the discussion of which is herein incorporated by reference.

At block 208, the server 102 triggers running of the interactive container (e.g., GUI software container 124). Triggering the running of the interactive container can include transmitting an indication over the encrypted network tunnel 118 to the edge server 120. In some embodiments, the trigger can be transmitted in response to a user, via the user device 114, initiating the computations. At block 210, the edge server 120 runs the interactive application in an isolated container, such that this container does not have access to any network communication and only has access to the selected and authorized datasets that are provided to the container with read-only permissions. In some embodiments, this can include the client agent 128 reading the container image from the container registry 116 and then running the code on the cohort generated at block 206 (i.e., the data maintained by site data system 132). In other words, the code is executed “on-premises” or “on-site” for the cohort. In some embodiments, the cohort data is exported to a local directory and made accessible to the container 124. In some embodiments, an adapter can be used that will allow the container to interact with the data without requiring it to be exported from the site data system 132. In some embodiments, once the container code finishes running, the result of the container code is accessed by client agent 128 (e.g., as files in the edge file system 122) and can be imported into the client agent 128 in different ways, for example as a cohort with or without imaging data, video data, textual data, and/or other data types. In some embodiments, the container code is limited to accessing only the input cohort data on the local file system 126. In some embodiments, the container code is prevented from performing communication with any other service in client agent 128 (e.g., databases). In some embodiments, the container code is prevented from performing any communication with external systems. In this manner, the code is executed “on-premises” or “on-site” for each selected cohort in a safe and secure manner, preventing data leakage and/or access to unauthorized resources, and sensitive data is prevented from leaving its associated network. In addition, the container for the interactive application is run in complete isolation, with no access to data and networking except the data authenticated to be run on it.

At block 212, the server 102 transmits an application link to the user device 114. In some embodiments, this can include generating a URL for the user to access the interactive session with GUI software container 124. At block 214, once the user device 114 has received the application link, the user would then access the link to the application and the server 102 (via proxy 112) performs an authentication and authorization procedure on the user of user device 114. At block 216, once the user has been authenticated and authorized, the server 102 establishes a connection between the GUI software container 124 and the user device 114 via the encrypted network tunnel 118. In some embodiments, running the user container image can be initiated via an asynchronous message queue mechanism or via a synchronous communication mechanism, where a virtual network computing application and a window server container are created and run. In some embodiments, the containers can share virtual hardware resources. At block 218, the server 102 passes signals and indications from the user device 114 to the GUI software container 124 via the encrypted network tunnel 118. In some embodiments, the signals and indications can include mouse movements, clicks, and keyboard key presses. In other words, the server 102 and the encrypted network tunnel 118 enable the user to interact directly via the user device 114 with the output of the containerized code that was computed at the site of the site data system 132 and on the data contained only at the site of the site data system 132 in a secure and distributed manner. This is because only the specific user interface of the associated application is passed over the encrypted network tunnel 118 to the user device 114.

In some embodiments, the user can request, via user device 114, to explicitly terminate the session. In some embodiments, the session can terminate automatically based on inactivity or a general timeout procedure. In some embodiments, the user, after being authenticated and authorized again, can rejoin the session after closing out or shutting off the user device 114.

FIG. 3 is another example process 300 for interactive distributed computing, according to some embodiments of the present disclosure. In some embodiments, process 300 can be performed via a client agent installed on-premises, such as client agent 128. At block 302, client agent 128 executes an interactive application in an isolated container. The code for the interactive application can have been received via the encrypted network tunnel 118 from the server 102 and the user device 114. At block 304, the client agent 128 receives a connection to the GUI software container 124 from the user device 114. At block 306, the client agent 128 receives signals and indications from the user device 114 via the encrypted network tunnel 118. As discussed above, the signals and indications can include mouse movements, clicks, and keyboard key presses. At block 308, the client agent 128 applies the signals and indications from the user device 114 to the GUI container 124 to manipulate the user interface based on such signals and indications. In this manner, the user can interact directly via the user device 114 with the output of the containerized code that was computed at the site of the site data system 132 and on the data contained only at the site of the site data system 132 in a secure and distributed manner. This is because only the specific user interface of the associated application is passed over the encrypted network tunnel 118 to the user device 114.

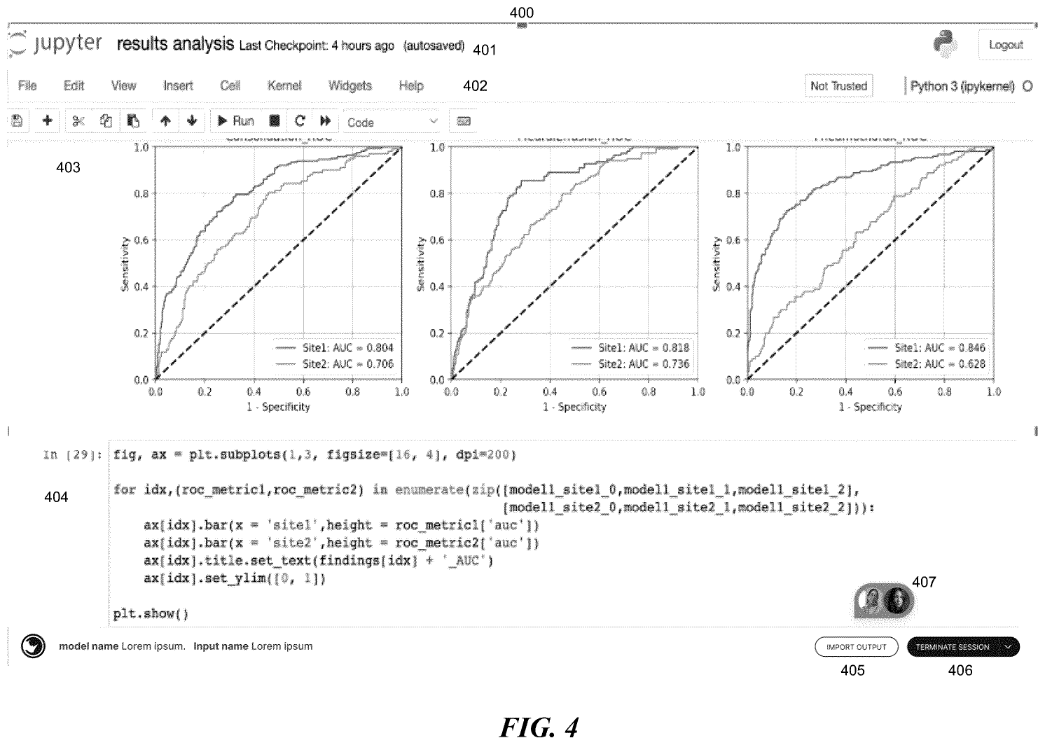

FIG. 4 is an example user interface 400 within the system of FIG. 1, according to some embodiments of the present disclosure. For example, the user interface 400 can be displayed on a user device 114, allowing a user to interact with data and a containerized model executing at a location remote from the user, such as at the site or location of the site data system 132. Interface 400 displays an example Jupyter Notebook page that a user can use to access the results and container. The user interface 400 includes a header 401 that indicates a title of the project and a last checkpoint or last login/save. The user interface 400 also includes a taskbar 402 which a user can use to manipulate their findings. In addition, the user interface 400 includes a window 403 that displays visual or graphical representations of the outputs from the container executed by the client agent 128. The user interface 400 further includes a region 404 that displays the code that was manually entered by the user during the interactive session. The user interface 400 can further include a button 405 to import an output from the GUI container 124, a button 406 to terminate the session, and an indicator 407 identifying the users that are currently accessing the project.

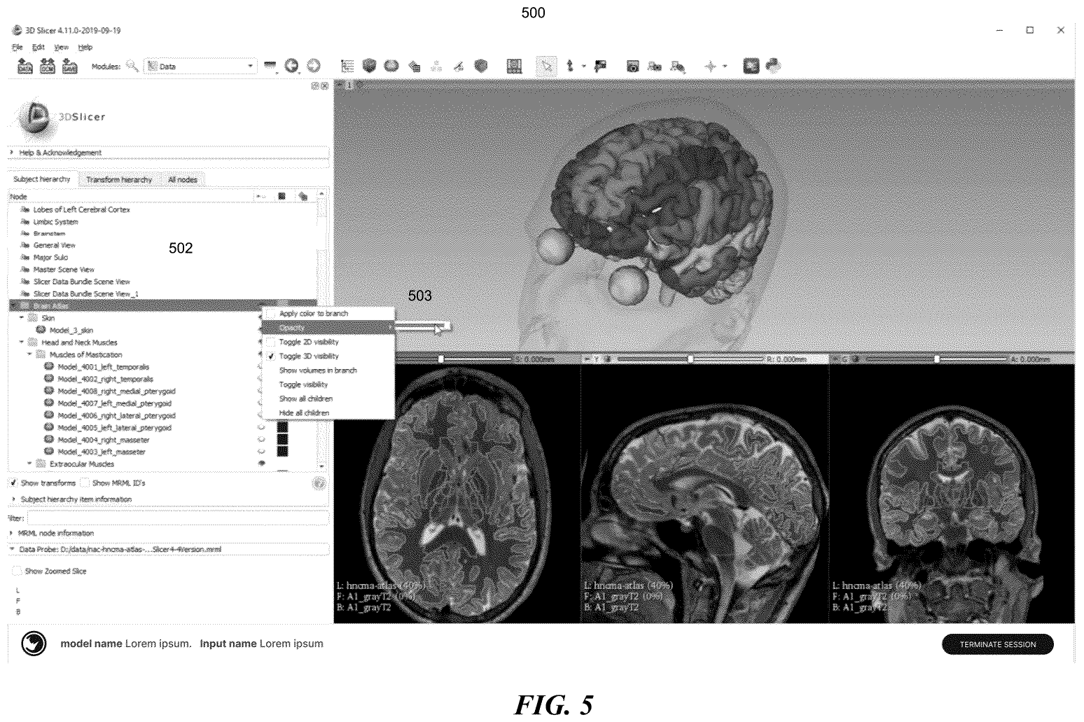

FIG. 5 is another example user interface 500 within the system of FIG. 1, according to some embodiments of the present disclosure. The user interface 500 is another example of an interface that can be displayed on a user device 114, allowing a user to interact with data via a containerized application executing at a location remote form the user. User interface 500 displays an example 3DSlicer page. The user interface 500 can include a list of data points that were made available to the container 502. In addition, the user interface 500 includes a window 503 that provides visual representations of medical imaging data from the selected data point.

FIG. 6 is a diagram of an example server device 600 that can be used within system 100 of FIG. 1. Server device 600 can implement various features and processes as described herein. Server device 600 can be implemented on any electronic device that runs software applications derived from complied instructions, including without limitation personal computers, servers, smart phones, media players, electronic tablets, game consoles, email devices, etc. In some implementations, server device 600 can include one or more processors 602, volatile memory 604, non-volatile memory 606, and one or more peripherals 608. These components can be interconnected by one or more computer buses 610.

Processor(s) 602 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 610 can be any known internal or external bus technology, including but not limited to ISA, EISA, PCI, PCI Express, USB, Serial ATA, or Fire Wire. Volatile memory 604 can include, for example, SDRAM. Processor 602 can receive instructions and data from a read-only memory or a random access memory or both. Essential elements of a computer can include a processor for executing instructions and one or more memories for storing instructions and data.

Non-volatile memory 606 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 606 can store various computer instructions including operating system instructions 612, communication instructions 614, application instructions 616, and application data 617. Operating system instructions 612 can include instructions for implementing an operating system (e.g., Mac OS®, Windows®, or Linux). The operating system can be multi-user, multiprocessing, multitasking, multithreading, real-time, and the like. Communication instructions 614 can include network communications instructions, for example, software for implementing communication protocols, such as TCP/IP, HTTP, Ethernet, telephony, etc. Application instructions 616 can include instructions for various applications. Application data 617 can include data corresponding to the applications.

Peripherals 608 can be included within server device 600 or operatively coupled to communicate with server device 600. Peripherals 608 can include, for example, network subsystem 618, input controller 620, and disk controller 622. Network subsystem 618 can include, for example, an Ethernet of WiFi adapter. Input controller 620 can be any known input device technology, including but not limited to a keyboard (including a virtual keyboard), mouse, track ball, and touch-sensitive pad or display. Disk controller 622 can include one or more mass storage devices for storing data files; such devices include magnetic disks, such as internal hard disks and removable disks; magneto-optical disks; and optical disks.

FIG. 7 is an example computing device that can be used within the system 100 of FIG. 1, according to an embodiment of the present disclosure. The illustrative user device 700 can include a memory interface 702, one or more data processors, image processors, central processing units 704, and/or secure processing units 705, and peripherals subsystem 706. Memory interface 702, one or more central processing units 704 and/or secure processing units 705, and/or peripherals subsystem 706 can be separate components or can be integrated in one or more integrated circuits. The various components in user device 700 can be coupled by one or more communication buses or signal lines.

Sensors, devices, and subsystems can be coupled to peripherals subsystem 706 to facilitate multiple functionalities. For example, motion sensor 710, light sensor 712, and proximity sensor 714 can be coupled to peripherals subsystem 706 to facilitate orientation, lighting, and proximity functions. Other sensors 716 can also be connected to peripherals subsystem 706, such as a global navigation satellite system (GNSS) (e.g., GPS receiver), a temperature sensor, a biometric sensor, magnetometer, or other sensing device, to facilitate related functionalities.

Camera subsystem 720 and optical sensor 722, e.g., a charged coupled device (CCD) or a complementary metal-oxide semiconductor (CMOS) optical sensor, can be utilized to facilitate camera functions, such as recording photographs and video clips. Camera subsystem 720 and optical sensor 722 can be used to collect images of a user to be used during authentication of a user, e.g., by performing facial recognition analysis.

Communication functions can be facilitated through one or more wired and/or wireless communication subsystems 724, which can include radio frequency receivers and transmitters and/or optical (e.g., infrared) receivers and transmitters. For example, the Bluetooth (e.g., Bluetooth low energy (BTLE)) and/or WiFi communications described herein can be handled by wireless communication subsystems 724. The specific design and implementation of communication subsystems 724 can depend on the communication network(s) over which the user device 700 is intended to operate. For example, user device 700 can include communication subsystems 724 designed to operate over a GSM network, a GPRS network, an EDGE network, a WiFi or WiMax network, and a Bluetooth™ network. For example, wireless communication subsystems 724 can include hosting protocols such that device 700 can be configured as a base station for other wireless devices and/or to provide a WiFi service.

Audio subsystem 726 can be coupled to speaker 728 and microphone 730 to facilitate voice-enabled functions, such as speaker recognition, voice replication, digital recording, and telephony functions. Audio subsystem 726 can be configured to facilitate processing voice commands, voice-printing, and voice authentication, for example.

I/O subsystem 740 can include a touch-surface controller 742 and/or other input controller(s) 744. Touch-surface controller 742 can be coupled to a touch-surface 746. Touch-surface 746 and touch-surface controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 746.

The other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of speaker 728 and/or microphone 730.

In some implementations, a pressing of the button for a first duration can disengage a lock of touch-surface 746; and a pressing of the button for a second duration that is longer than the first duration can turn power to user device 700 on or off. Pressing the button for a third duration can activate a voice control, or voice command, module that enables the user to speak commands into microphone 730 to cause the device to execute the spoken command. The user can customize a functionality of one or more of the buttons. Touch-surface 746 can, for example, also be used to implement virtual or soft buttons and/or a keyboard.

In some implementations, user device 700 can present recorded audio and/or video files, such as MP3, AAC, and MPEG files. In some implementations, user device 700 can include the functionality of an MP3 player, such as an iPod™. User device 700 can, therefore, include a 36-pin connector and/or 8-pin connector that is compatible with the iPod. Other input/output and control devices can also be used.

Memory interface 702 can be coupled to memory 750. Memory 750 can include high-speed random access memory and/or non-volatile memory, such as one or more magnetic disk storage devices, one or more optical storage devices, and/or flash memory (e.g., NAND, NOR). Memory 750 can store an operating system 752, such as Darwin, RTXC, LINUX, UNIX, OS X, Windows, or an embedded operating system such as VxWorks.

Operating system 752 can include instructions for handling basic system services and for performing hardware dependent tasks. In some implementations, operating system 752 can be a kernel (e.g., UNIX kernel). In some implementations, operating system 752 can include instructions for performing voice authentication.

Memory 750 can also store communication instructions 754 to facilitate communicating with one or more additional devices, one or more computers and/or one or more servers. Memory 750 can include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic messaging-related process and functions; web browsing instructions 764 to facilitate web browsing-related processes and functions; media processing instructions 766 to facilitate media processing-related functions and processes; GNSS/Navigation instructions 768 to facilitate GNSS and navigation-related processes and instructions; and/or camera instructions 770 to facilitate camera-related processes and functions.

Memory 750 can store application (or “app”) instructions and data 772, such as instructions for the apps described above in the context of FIGS. 2-6. Memory 750 can also store other software instructions 774 for various other software applications in place on device 700.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A system for providing interactive distributed computation comprising:
a server accessible by a client agent, the client agent residing on a network associated with a site;
wherein the server comprises instructions which, when executed by one or more processors, cause the server to perform a process operable to:
create a project based on an indication received from a user device external from the network of the client agent;
receive a software container image from the user device, the container image comprising code to be executed and a user interface component;
identify a dataset accessible by the client agent;
associate at least a subset of the dataset with the project;
trigger execution of the container image by the client agent, wherein the client agent executes a software container based on the software container image in an isolated manner;
transmit a link to access a user interface (UI) of the container image to the user device;
in response to receiving an indication that the user device has accessed the link, authenticating the user device and validating an authorization of the user device to access the UI of the container image;
establish a connection between the user device and the isolated container, the connection comprising an encrypted communication channel;
pass signals from the user device to the isolated container; and
pass signals from the isolated container to the user device.

2. The system of claim 1, wherein passing the signals from the user device to the isolated container comprises passing at least one of mouse movements, clicks, and keyboard key presses to the user device.

3. The system of claim 1, wherein the system comprises a network policy on the isolated container that blocks outgoing access.

4. The system of claim 1, wherein the server communicates with the client agent via an asynchronous message queue mechanism or via a synchronous communication mechanism.

5. The system of claim 1, wherein the user interface component comprises a containerized application.

6. The system of claim 1, wherein the server is configured to terminate a session automatically after a predefined idle period or based on an indication from the user device.

7. The system of claim 1, wherein authenticating and authorizing the user device comprises authenticating using at least one of a username and password, single-sign on (SSO), JSON web token (JWT), or valid authentication token, and authorizing comprises at least one of role based access control (RBAC) permission checks, user-based access, access to any authenticated user, or public access.

8. The system of claim 1, wherein the encrypted communication channel is configured to encrypt all data sent over the connection.

9. The system of claim 8, wherein the encrypted communication channel comprises a Transport Layer Security (TLS) tunnel.

10. The system of claim 1, wherein the server is configured to store an identifier of an interactive session in a cloud database and an indicator that the interactive session is active.

11. The system of claim 10, wherein the server is configured to query the cloud database at a predetermined frequency to determine whether the interactive session is active.

12. A distributed computing system comprising:
a client agent that resides on a network and is communicably coupled to a server that resides outside of the network, the client agent comprising instructions which, when executed by one or more processors, cause the client agent to perform a process operable to:
receive a software container image from the server via an encrypted communication channel, the container image comprising code to be executed and a user interface component;
execute the container image in an isolated manner;
receive a connection to a user device via the encrypted communication channel;
receive, by the isolated container, signals from the user device; and
manipulate a user interface displayed on the user device based on the signals received from the user device.

13. The distributed computing system of claim 12, wherein passing the signals comprises at least one of mouse movements, clicks, and keyboard key presses at the user device.

14. The distributed computing system of claim 12, wherein the system comprises a network policy on the isolated container that blocks outgoing access.

15. The distributed computing system of claim 12, wherein the server communicates with the client agent via an asynchronous message queue mechanism or via a synchronous communication mechanism.

16. The distributed computing system of claim 12, wherein the user interface component comprises a containerized application.

17. The distributed computing system of claim 12, wherein the encrypted communication channel is configured to encrypt all data sent over the connection.

18. The distributed computing system of claim 17, wherein the encrypted communication channel comprises a Transport Layer Security (TLS) tunnel.

19. The distributed computing system of claim 12, wherein the client agent comprises at least one of a cloud-based server in a virtual private cloud, an on-site provisioned virtual machine, or an on-site server with access to data in a network and compute processing devices including one or more of CPUs or GPUs.

20. The distributed computing system of claim 16, wherein the containerized application comprises at least one of a viewing or annotation tool.
